(19) United States
(12) Patent Application Publication
(10) Pub. No.: US 2005/0218190 A1
(43) Pub. Date: Oct. 6, 2005

(54) Configuring apparatus and processing method of thermal conductive plate

(76) Inventors: Meng-Cheng Huang, Taipei (TW); Wen-Hae Tseng, Taipei (TW); Tony Wang, Taipei (TW)

Correspondence Address: Yi-Wen Tseng, 4331 Stevens Battle Lane, Fairfax, VA, 22033, US

(21) Appl. No.: 10/816,920

(22) Filed: Apr. 5, 2004

(51) Int. Cl. B23K 37/04

(52) U.S. Cl. 228/49.4; 228/6.1

(57) ABSTRACT

This invention provides a configuring apparatus and a processing method for a thermal conductive plate, which uses high-temperature fusion to seal a top plate and a bottom plate of the thermal conductive plate together. Thereby, the sealing condition is improved to enhance yield. Further, the processing method speeds up fabrication of the thermal conductive plate to aid in execution of automatic process.

### BACKGROUND OF THE INVENTION

The present invention relates in general to a configuring apparatus and a processing method for a thermal conductive plate, and more particular, to a method using high-temperature fusion to seal individual plates of a thermal conductive plate.

The conventional thermal conductive plate includes a top plate and a bottom plate laminated together to form a thin hollow shell. A wick structure and a working fluid are introduced within the shell, and the joint between the top plate and the bottom plate is sealed by brazing. A vacuum step is performed between the brazing step. However, the brazing step results in poor sealing effect of the thermal conductive plate, so that the yield is typically poor. Further, the cost for fabricating this type of thermal conductive plate is high.

To resolve the problems caused by the conventional thermal conductive plate as described above, the Applicant, with many years of experience in this field, has developed a configuring apparatus and a processing method for a thermal conductive plate as described as follows.

### BRIEF SUMMARY OF THE INVENTION

The present invention provides a configuring apparatus and a processing method for a thermal conductive plate. High-temperature fusion is applied to seal the thermal conductive plate, such that the yield is enhanced, and the fabrication is speeded up to aid in automatic execution.

The configuring apparatus provide by the present invention includes a working platform, a first and a second lamination units and a movable fusion head. The working platform includes a positioning seat for holding the thermal conductive plate. The first and second lamination units are disposed at two sides of the positioning seat for pressing the thermal conductive plate on the positioning seat. The fusion head is located over the positioning seat to seal the thermal conductive plate by high-temperature fusion.

The processing method provided by the present invention includes performing high-temperature fusion on joint of individual plates of the thermal conductive plate.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 illustrates a perspective view of a configuring apparatus for a thermal conductive plate;

FIG. 2 is a local enlargement of a semi-manufactured thermal conductive plate disposed in the configuring apparatus;

FIG. 3 is a schematic drawing showing the operation of the configuring apparatus;

FIG. 4 is a schematic drawing showing another operation status of the configuring apparatus;

FIG. 5 is a schematic drawing showing another operation status of the configuring apparatus; and

FIG. 6 is a schematic drawing showing another operation status of the configuring apparatus.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

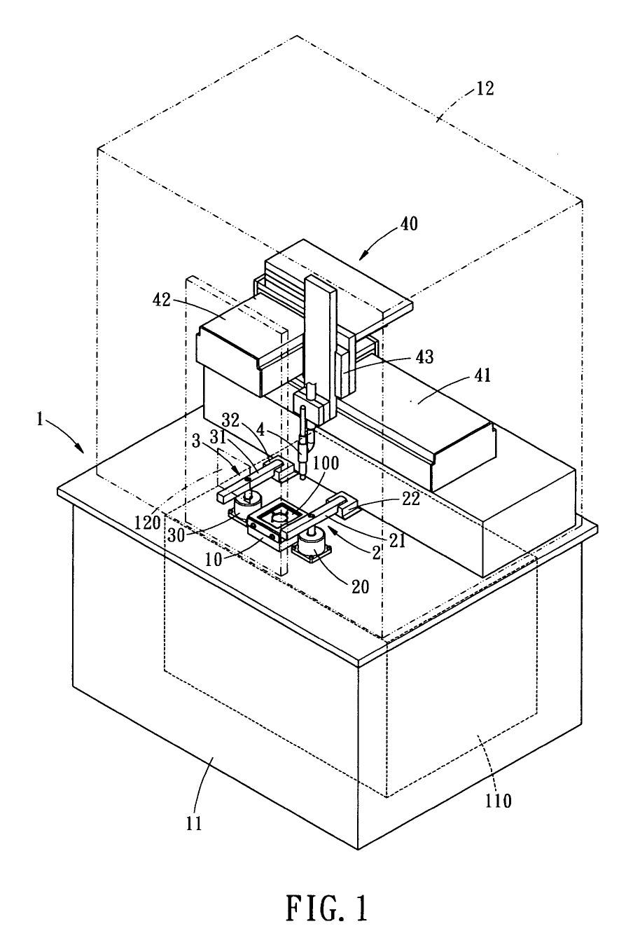

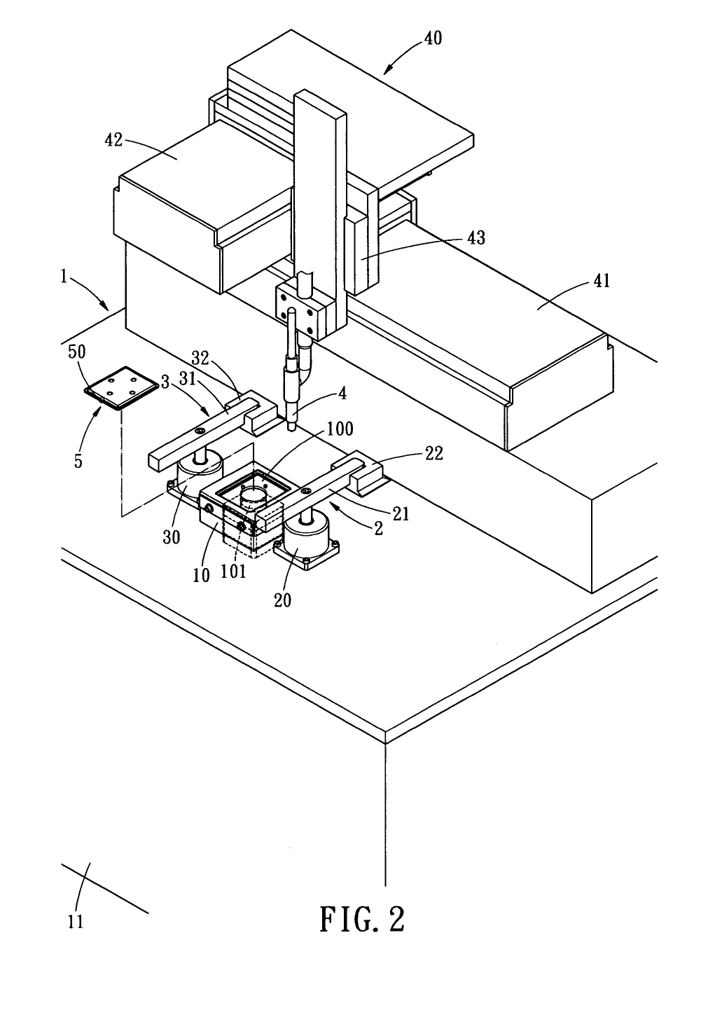

Referring to FIGS. 1 and 2, a configuring apparatus for a thermal conductive plate and a semi-manufactured thermal conductive plate disposed in the configuring apparatus are illustrated. As shown, the present invention provides a configuring apparatus that uses high-temperature fusion to seal the thermal conductive plate 5. As shown, the configuring apparatus includes a working platform 1, a first laminating unit 2, a second laminating unit 3 and a moveable fusion head 4.

The working platform 1 is used to carry the above elements, such that each of the first and second laminating units 2 and 3 and the moveable fusion head 4 are disposed thereon to perform sealing operation of the thermal conductive plate 5. The working platform 1 includes a positioning seat 10 in which the thermal conductive plate 5 is disposed. The positioning seat 10 includes a recessed slot 100 for receiving the thermal conductive plate 5 therein and a moving unit 101 underneath the recessed slot 100. The moving unit 101 is operative to push the thermal conductive plate 5 upwardly, such that the thermal conductive plate 5 can be easily removed from the positioning seat 10.

A box member 11 can be disposed under the working platform 1. The box member 11 includes a heat circulating and dissipating system 110. The heat circulating and dissipating system 10 circulate and dissipate heat by cooling liquid. Large size dissipating fan may also be used to dissipate the heat by air. During the sealing operation of the thermal conductive plate 5, individual plates of the thermal conductive plate 5 is joined and sealed by high-temperature fusion, such that the heat circulating and dissipating system 10 is particularly design for heat exchange to reduce the temperature of the thermal conductive plate 5. The positioning seat 10 is preferably fabricated from material with good conductivity such as copper. Therefore, the heat of the thermal conductive plate 5 can thus be conducted towards the positioning seat 10 easily to be dissipated.

The first laminating unit 2 and the second laminating unit 3 are placed at left and right sides of the positioning seat 10, respectively. The first and second laminating units 2 and 3 each comprise the rotation seats 20 and 30 mounted to the working platform 1. Suspending arms 21 and 31 connected to the rotation seats 20 and 30 are driven thereby, respectively. Lamination members 22 and 32 are formed at free ends of the suspending arms 21 and 31. When the thermal conductive plate 5 is disposed in the recessed slot 100 of the positioning seat 10, the lamination members 22 and 32 stably press the thermal conductive plate 5 on the positioning seat 10 to perform sealing operation thereon.

The moveable fusion head 4 is located over the positioning seat 100. The moveable fusion head 4 is supported by a coordinate mechanism 40 on the working platform 1. The coordinate mechanism 40 includes an X-slide track 41, a Y-slide track 42 and a Z-slide track 43, such that the fusion head 4 can displace along the X-axis, Y-axis and Z-axis as required. When a predetermined path is configured, the fusion head 4 is controlled by the coordinate mechanism 40 along the predetermined path to reach a specific location.

In addition, an enclosure 12 may be used for masking the first laminating unit 2, the second laminating unit 3 and the fusion head 4. A transparent window 120 may be formed in the enclosure 12 for monitoring the operation status inside of the enclosure 12.

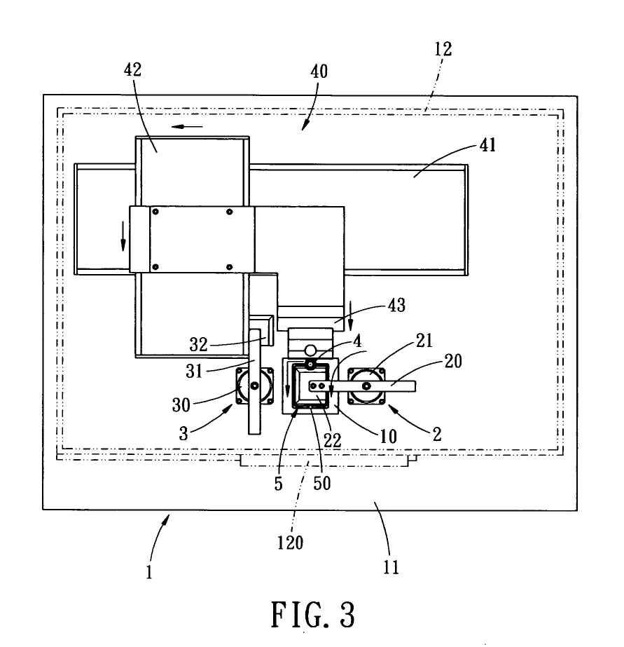

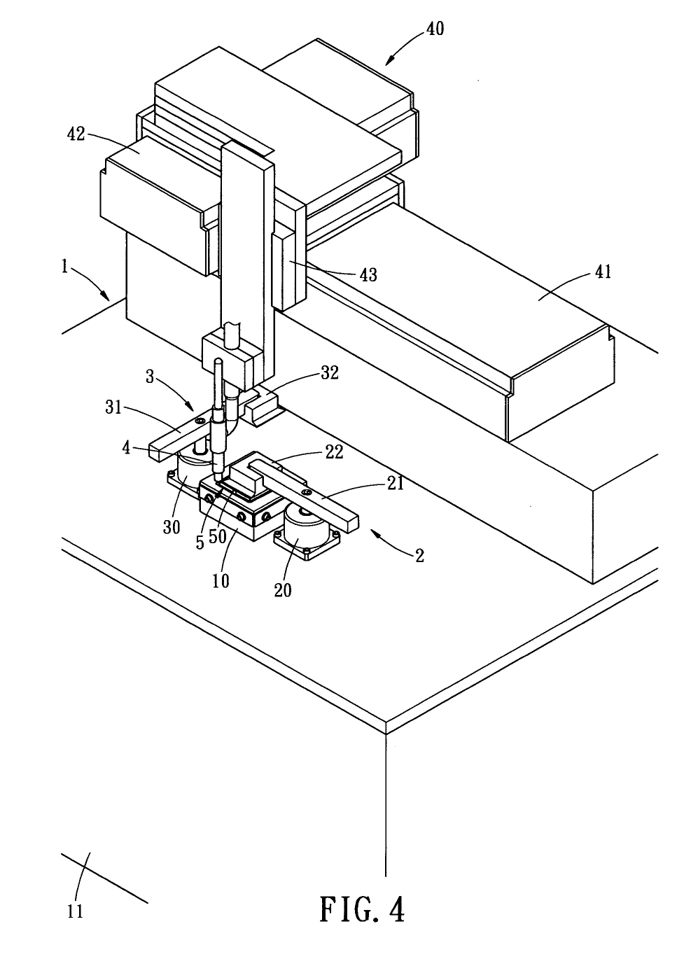

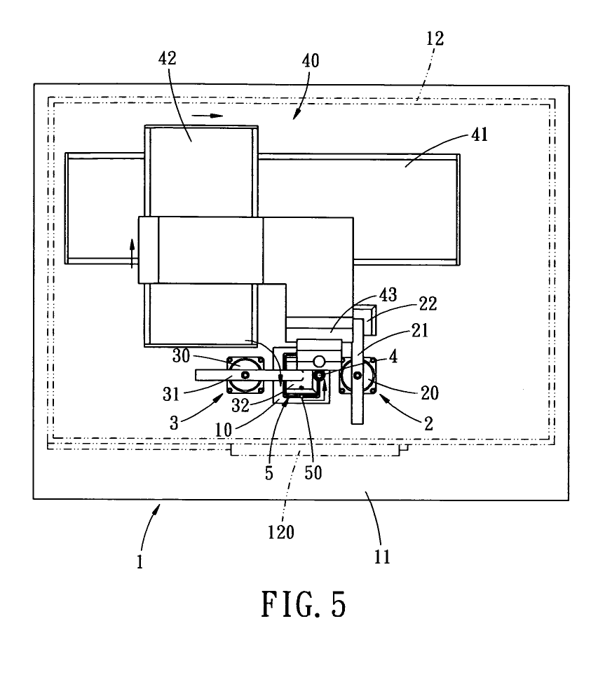

As shown in FIGS. 2 and 3, when the semi-manufactured thermal conductive plate 5 is disposed in the recessed slot 100 of the positioning seat, the first laminating unit 2 presses the thermal conductive plate 5 on the positioning seat 10. As shown in FIG. 4, the fusion head 4 is directed along a predetermined path to seal joint of individual plates of the thermal conductive plate 5. When the fusion head 5 travels through exhaust outlet 50, the fusion head 4 is elevated thereover. As shown in FIG. 5, the first laminating unit 2 is withdrawn away from the positioning seat 10, and the second laminating unit 2 presses the thermal conductive plate 5 on the positioning seat 10 until the fusion head 4 finished the fusion process along the whole predetermined path and returns to the starting point.

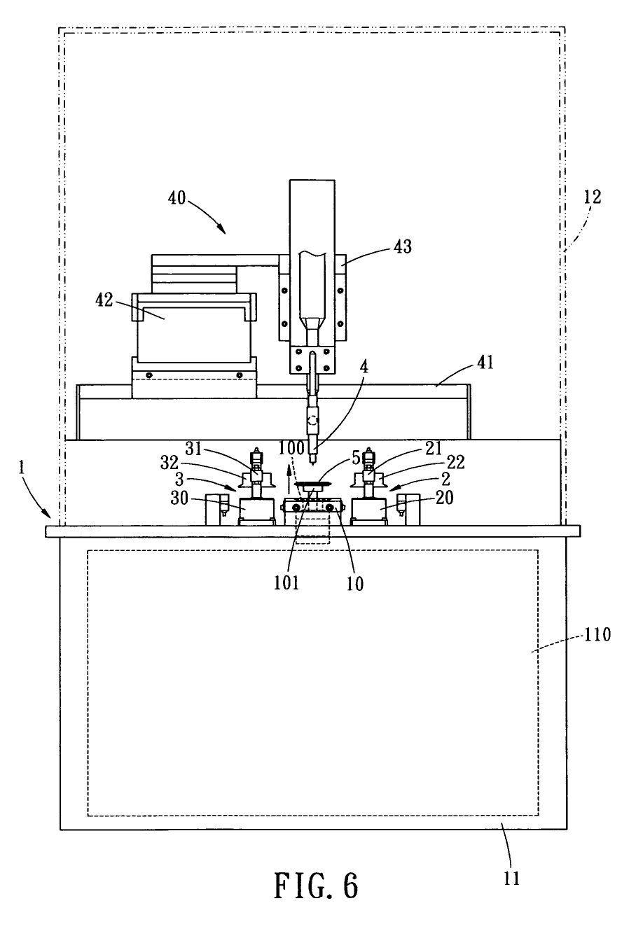

As shown in FIG. 6, when the fusion head 4 is elevated over the exhaust outlet 50, the second laminating unit 2 is withdrawn out of the positioning seat 10. Meanwhile, the moving unit 101 pushes the thermal conductive plate 5 upwardly over the recessed slot 100, such that the operator or the user can easily remove the thermal conductive plate 5 away from the positioning seat 10 for subsequent process.

Thereby, a configuring apparatus for a thermal conductive plate is obtained.

The present invention further comprises a processing method for configuring a thermal conductive plate. In the conventional fabrication of a thermal conductive plate 5, the processes of cleaning the raw material, disposing copper powder into a plate member, forming capillary structure by high-temperature sintering the powder, assembling the plate, sealing the plate, installing exhaust pipe, soldering the soldering material, high temperature recovery, quality adjustment, filling working fluid, vacuuming, and sealing brazing are required. By this invention, the sealing operation is performed by high-temperature fusion, and therefore, several processes can be eliminated.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

1. A configuring apparatus for a thermal conductive plate, comprising:
a working platform, including a positioning seat thereon to receive the thermal conductive plate therein;
a first laminating unit, mounted to the working platform at one side of the positioning seat;
a second laminating unit, mounted to the working platform at the other side of the positioning seat; and
a moveable fusion, mounted to the working platform over the positioning seat;
wherein the first and second laminating units sequentially press the thermal conductive plate on the positioning seat allowing the fusion head to perform sealing operation thereon.

2. The apparatus of claim 1, further comprising a heat circulating and dissipation system under the working platform, and the positioning seat is fabricated from thermal conductive material.

3. The apparatus structure of claim 2, wherein the thermal conductive material includes copper.

4. The apparatus structure of claim 1, wherein the positioning seat includes a recessed slot for receiving the thermal conductive plate therein.

5. The apparatus of claim 4, wherein the positioning seat includes a moving unit underneath the recessed slot to push the thermal conductive plate upwardly over the recessed slot.

6. The apparatus of claim 1, further comprising the first and second laminating units comprise a first and a second rotation seats mounted to the working platform, respectively, and a first and a second suspending arms driven by the first and second rotation seats, respectively.

7. The apparatus of claim 6, wherein first and second laminating units further comprise a first and a second lamination members formed at free ends of the first and second suspending arms, respectively.

8. The apparatus of claim 1, further comprising a coordinate mechanism mounting the fusion head to the working platform.

9. The apparatus of claim 8, wherein the coordinate mechanism includes an X-axis slide track, an Y-axis slide track and a Z-axis slide track for driving the fusion head to move along X-axis, Y-axis and Z-axis.

10. The apparatus of claim 1, further comprising an enclosure for masking the working platform, the first and second laminating units, and the moveable fusion head therein.

11. The apparatus of claim 10, wherein the enclosure includes a transparent window.

12. A method for processing a thermal conductive plate joined individual plates, the method includes a step of high-temperature fusion performed on a joint between the individual plates.
